(19) United States
(12) Patent Application Publication
(10) Pub. No.: US 2004/0044907 A1
(43) Pub. Date: Mar. 4, 2004

(54) Method of self-adjusting sensitivity for filtering documents

(76) Inventor: Hung-Ming Sun, Yunlin (TW)

Correspondence Address: BIRCH STEWART KOLASCH & BIRCH, PO BOX 747, FALLS CHURCH, VA, 22040-0747, US

(21) Appl. No.: 10/231,112

(22) Filed: Aug. 30, 2002

(51) Int. Cl. G06F 11/30

(52) U.S. Cl. 713/201

(57) ABSTRACT

A method for filtering documents. The method comprises steps of (a) filtering the documents using a sensitivity and calculating the number of the documents blocked by the filtering, (b) receiving the number of documents mistakenly blocked by the filtering to calculate the error rate, (c) increasing (decreasing) the sensitivity by a displacement, (d) repeating steps (a) and (b) with the new sensitivity, (e) if the error rate reduces, going back to step (a) and keeping increasing (decreasing) the sensitivity; if the error rate is raised, going back to step (a) but decreasing (increasing) the sensitivity instead.

### BACKGROUND OF THE INVENTION

1. Field of the Invention

The present invention relates to digital document filtering and particularly to a method of self-adjusting sensitivity for filtering documents such as email, that adjusts and optimizes sensitivity used for a filtering system.

2. Description of the Prior Art

FIG. 1 is a diagram showing a network system comprising an email server. The client computers or work stations 151 and 152 communicating with the email server 13 through a switch 14 are installed with email browsers such as MICROSOFT OUTLOOK®. When people send email from the Internet 11 to users working with the client computers 151 and 152, the email is first transferred through a firewall 12 and stored into different user accounts of the email server 13. The client users can read the email kept stored in the email server 13, or download them from the server 13 using the email browser.

As email becomes more and more popular, commercial advertisement or other unsolicited email is easily spread. Therefore, a filter is necessary for the server to block or identify unwanted messages for the email users.

In a conventional email filter, a recognition system is responsible for identification of unwanted messages. The recognition system is generally controlled by a set of parameters to determine its sensitivity. With a high sensitivity setting, more unwanted messages could be captured, but possibly the normal messages would be easily blocked. On the contrary, with a low sensitivity, mistaken normal messages could be reduced but unwanted messages may easily go through. Therefore, the determination of the sensitivity is critical for the system performance. However, a common case is that the choice of the sensitivity is made by the system administrator based on his subjective policies. It would not be known if it is a proper setting for the real situation. Moreover, for email filtering, the intention of each email user to send improper messages is different; some people may do it very often but others only occasionally or even never. Hence, it would be better to treat different email users with the sensitivities matching their behavior.

### SUMMARY OF THE INVENTION

The object of the present invention is to provide a method for filtering documents which automatically adjusts the screening parameter or sensitivity based on the error or accuracy rate computed over a time period.

The present invention provides a method for filtering documents. The method comprises steps of (a) filtering the documents using a sensitivity and calculating a number of documents blocked by the filtering, (b) receiving a number of documents mistakenly blocked by the filtering to calculate an error rate computed by dividing the number of mistakenly blocked documents by the number of blocked documents, (c) increasing the sensitivity by a displacement to obtain a new sensitivity, (d) repeating steps (a) and (b) with the new sensitivity, and (e) increasing the new sensitivity by the displacement if the error rate obtained by step (d) is reduced, and decreasing the new sensitivity by the displacement if the error rate obtained by step (d) is raised.

The present invention further provides a method for filtering documents. The method comprises steps of (a) filtering the documents using a sensitivity and calculating a number of documents blocked by the filtering, (b) receiving a number of documents mistakenly blocked by the filtering to calculate an error rate computed by dividing the number of mistakenly blocked documents by the number of blocked documents, (c) decreasing the sensitivity by a displacement to obtain a new sensitivity, (d) repeating steps (a) and (b) with the new sensitivity; and (e) decreasing the new sensitivity by the displacement if the error rate obtained by step (d) is reduced, and increasing the new sensitivity by the displacement if the error rate obtained by step (d) is raised.

Thus, the screening parameter or sensitivity of the email filter is adjusted periodically according to the error or accuracy rate of the email filter. The sensitivity will converge to a value, which may yield the best accuracy, after a finite number of iterations.

### BRIEF DESCRIPTION OF THE DRAWINGS

The present invention will become more fully understood from the detailed description given hereinafter and the accompanying drawings, given by way of illustration only and thus not intended to be limitative of the present invention.

FIG. 1 is a diagram showing a network system comprising an email server.

FIG. 2 is a flowchart of a method for filtering documents according to one embodiment of the invention.

FIG. 3A is a diagram showing the relation between the sensitivity and the error rate.

FIG. 3B is a diagram showing the relation between the sensitivity and the accuracy rate.

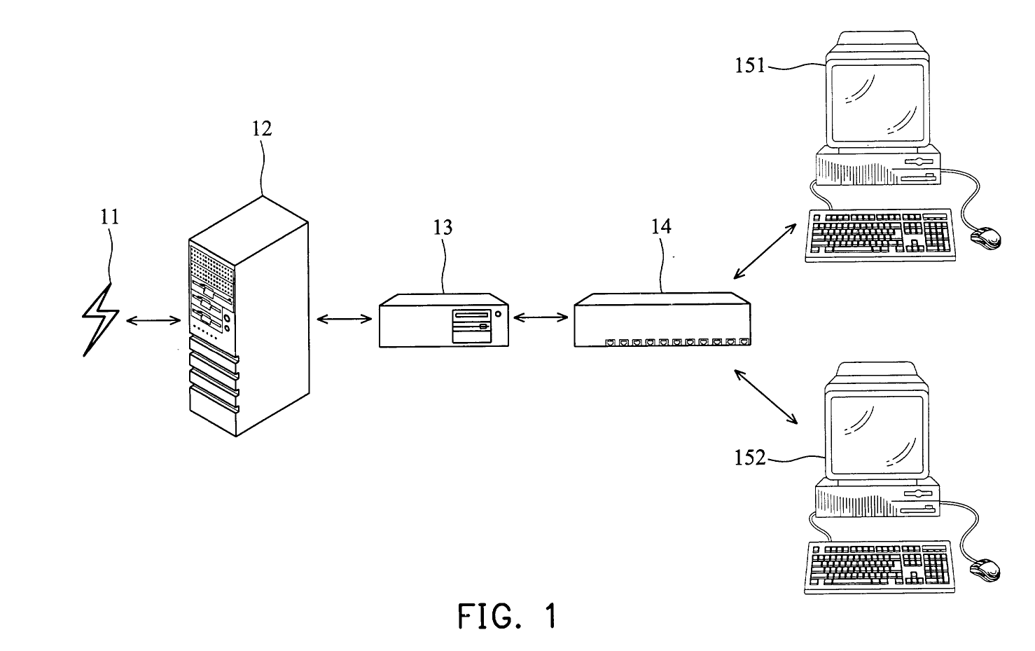

### DETAILED DESCRIPTION OF THE INVENTION

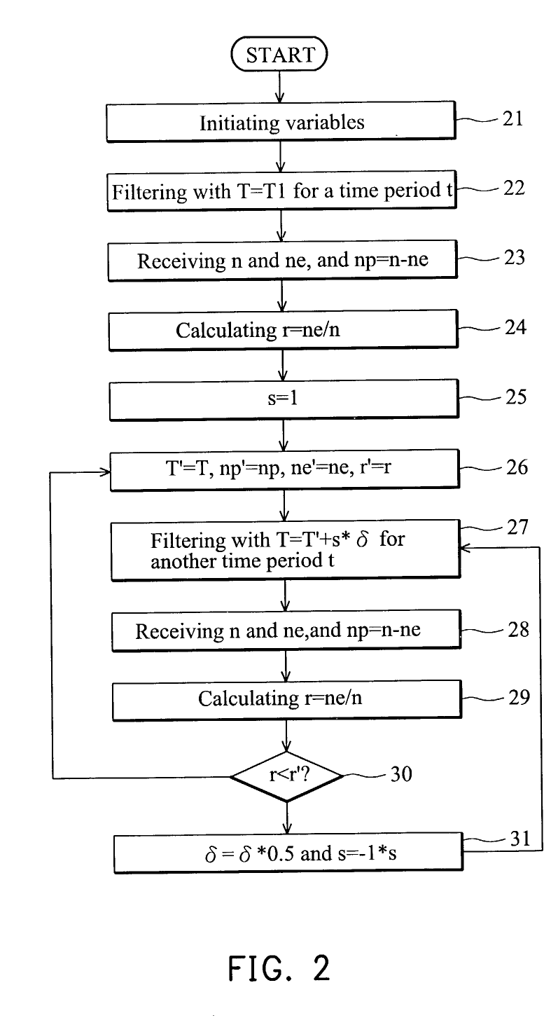

FIG. 2 is a flowchart of a method for dynamically filtering documents according to one embodiment of the invention.

In step 21, variables for sensitivities T and T′, the numbers of correctly blocked messages nₚ and nₚ′, the numbers of mistakenly blocked messages nₑ and nₑ′, error rates r, r′, a direction index s and a displacement 5 are initiated. An empty value is initially stored in each of them.

In step 22, an initial displacement value d is stored in the variable for the displacement δ and the sensitivity T is set to be an initial sensitivity T₁. The email from the Internet is filtered using T for a predetermined time period t (30 days for example). Unwanted messages are identified and blocked by the email filtering system.

In step 23, a total number n of the email messages are blocked by the filtering in step 22 during the time period. The administrator checks the blocked email to identify mistakenly blocked email. Suppose that there are ne messages that are mistakenly blocked in step 22. The number nₚ of the messages blocked correctly in step 22 can be computed by (n-nₑ).

In step 24, an error rate r is calculated as the ratio of nₑ to n.

In step 25, the direction index s is set to be 1.

In step 26, the sensitivity T′, the number of correctly and mistakenly blocked messages nₚ′ and nₑ′, and the error rate r′ are set to be the values of T, nₚ, nₑ and r respectively.

In step 27, the sensitivity T is updated with a value of (T′+s*δ). That is to say, the sensitivity is shifted by a displacement. The email from the Internet is filtered using the new T for another time period t.

In step 28, an operation similar to step 23 is repeated. A total number n of the email blocked by the filtering in step 27 during another time period t is calculated. The administrator checks the blocked email to identify the mistakenly blocked messages. Let the number of the mistakenly blocked messages be nₑ. The number nₚ of the messages blocked correctly is computed by (n-ne).

In step 29, a new error rate r is calculated as the ratio of nₑ to n.

In step 30, if the new error rate is smaller than the old value, go back to steps 26. If r is larger than r′, go to step 31.

In step 31, the displacement 5 and direction index s are revised with the values of (0.5*δ) and −1*s respectively, and then go back to steps 27.

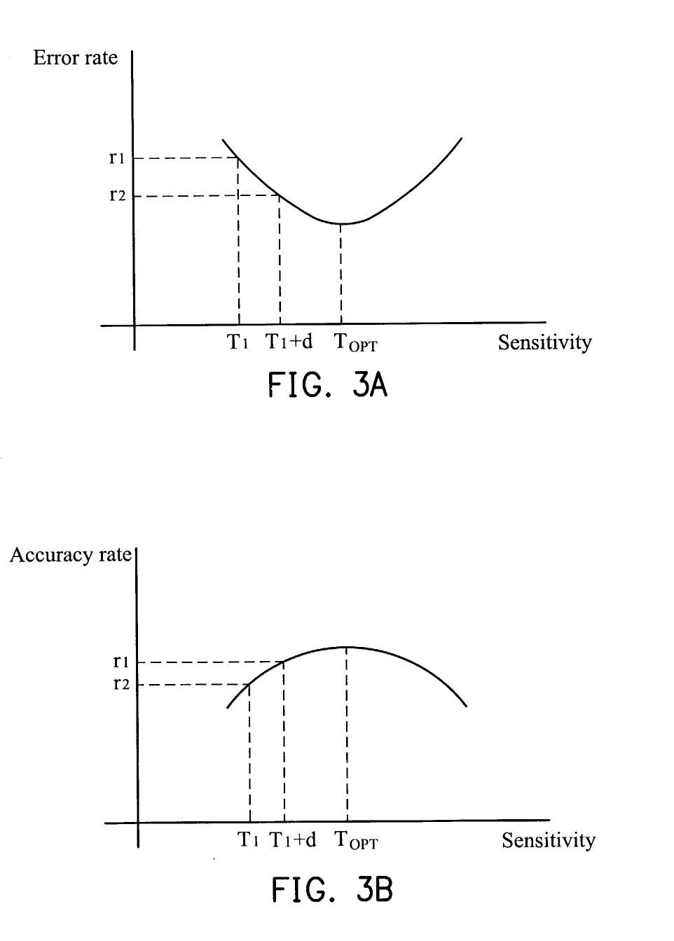

FIG. 3A is a diagram showing the relation between the sensitivity and the error rate. It should be noted that the relation between the sensitivity and the error rate could be expressed by a “U” curve. Suppose that a value T₁ is chosen as the initial sensitivity, i.e., T=T₁. Filtering email using T₁ will cause error rate r₁. According to the method of FIG. 2. The new sensitivity would be T=T₁+d. This new value of T will cause a new error rate r₂. Since r₂ is smaller than r₁, the sensitivity T will keep increasing until it reaches the right half of the “U” curve. As soon as the right half of the curve is reached, the new error rate will be larger than the old one. According to the method of FIG. 2., the T value will reduce and thus go back to approach T_{OPT}. At every return of the shift of the T value, its displacement is reduced by a factor of 0.5. Thus, the T value will approach to T_{OPT} after a number of iterations.

Alternatively, the relation between the sensitivity and the accuracy rate can also be used to implement the present invention. However, the method of FIG. 2 needs a little modification. First, the r value is redefined to be the accuracy rate calculated by nₚ/n in steps 24 and 29. Then, in step 30, if r>r′, go back to step 26; otherwise, go to step 31. FIG. 3B shows an operation of the modified method. It should be noted that the relation between the sensitivity and the accuracy rate is a “” curve.

By the previously described method, the email filter can adjust itself to get the best sensitivity setting. Moreover, in order to take into account the individual behavior of each email user, different email boxes could be filtered using different sensitivities. Each of the sensitivities can be optimized based on the error (accuracy) rate of each email box by the previously described method. This scheme can achieve a much more accurate filter than the conventional ones.

In conclusion, the present invention provides a method for better email filtering. The screening parameter or sensitivity of the email filter is adjusted automatically and periodically to get its best setting. The sensitivity converges to an optimal value after a finite number of iterations.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for filtering documents comprising steps of:
(a) filtering the documents using a sensitivity and calculating the number of documents blocked by the filtering;
(b) receiving the number of documents mistakenly blocked by the filtering to calculate an error rate using the number of mistakenly blocked documents by the number of blocked documents;
(c) increasing the sensitivity by a displacement to obtain a new sensitivity;
(d) repeating steps (a) and (b) with the new sensitivity;
(e) increasing the new sensitivity by the displacement if the error rate obtained by step (d) is reduced, and decreasing the new sensitivity by the displacement if the error rate obtained by step (d) is raised.

2. The method as claimed in claim 1, wherein the documents are email and the filtering blocks unwanted messages.

3. The method as claimed in claim 1, wherein the documents are filtered using the sensitivity over a predetermined time period.

4. The method as claimed in claim 1 further comprising step of:
reducing the displacement when decreasing the new sensitivity.

5. A method for filtering documents comprising steps of:
(a) filtering the documents using a sensitivity and calculating a number of documents blocked by the filtering;
(b) receiving a number of documents mistakenly blocked by the filtering to calculate an error rate using the number of mistakenly blocked documents by the number of blocked documents;
(c) decreasing the sensitivity by a displacement to obtain a new sensitivity;
(d) repeating steps (a) and (b) with the new sensitivity; and
(e) decreasing the new sensitivity by the displacement if the error rate obtained by step (d) is reduced, and increasing the new sensitivity by the displacement if the error rate obtained by step (d) is raised.

6. The method as claimed in claim 5, wherein the documents are email and the filtering blocks unwanted messages.

7. The method as claimed in claim 5, wherein the documents are filtered using the sensitivity over a predetermined time period.

8. The method as claimed in claim 5 further comprising step of:
reducing the displacement when increasing the new sensitivity.
